(19) United States
(12) Patent Application Publication
(10) Pub. No.: US 2010/0064543 A1
(43) Pub. Date: Mar. 18, 2010

(54) Set,comprising a household appliance and an additional part

(75) Inventor: Jacques Helot, Munchen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munchen (DE)

(21) Appl. No.: 12/311,041

(22) PCT Filed: Aug. 17, 2007
(86) PCT No.: PCT/EP2007/058586

§ 371 Date: Mar. 17, 2009

(30) Foreign Application Priority Data
Sep. 20, 2006 (DE) 10 2006 044 283.0

(51) Int. Cl. F26B 25/06; F26B 25/08

(52) U.S. Cl. 34/201; 34/239

(57) ABSTRACT

A set including a domestic appliance having a substantially horizontally extending covering plate, a substantially vertically extending wall in generally perpendicular abutment with the covering plate, and an additional part configured for attachment to the covering plate in a manner wherein the additional part projects from the wall; the set includes a clamp operatively associated with the additional part for engagement with the covering plate wherein the clamp includes a contact member configured for placement against the wall.

The present invention relates to a set comprising a domestic appliance with a covering plate oriented perpendicular to a vertical and an additional part, which can be attached to the covering plate in such a manner that it projects from a wall which is oriented approximately parallel to the vertical and adjoins the covering plate.

Such a set emerges from DE 102 23 539 A1. The domestic appliance of the set is a laundry appliance, in particular a washing machine, a tumble dryer or a combination appliance for both washing and drying laundry. The additional part of the set is a drying rack in the form of a lattice which when not required is arranged below the worktop in the domestic appliance and can be pulled out from there when needed. The drying rack can be moved in particular on rollers, the rollers running in U-shaped rails which are attached to the underside of the covering plate.

A shelf for a laundry basket is known from DE 20 2005 014 385 U1. This shelf comprises a U-shaped frame, which can be arranged below a domestic laundry appliance. The flat shelf can be pulled out of this frame when needed. The shelf can be combined with a domestic laundry appliance to form a set, with the domestic appliance being positioned in particular on the shelf.

The invention to be disclosed below relates in particular to the facilitation of activities an operator has to carry out when using a domestic laundry appliance. Such activities include:
collecting together the items to be laundered;
separating and combing collected items in different groups, depending on care requirements;
placing the items in a washing machine or tumble dryer;
locating and dosing laundry agents, in particular basic materials for washing and rinsing water;
folding and storing the laundered items, in some instances ironing.

Additional parts emerge from the cited documents of the prior art, which can be attached or are attached to a corresponding domestic appliance and can assist with such activities, for example by providing storage options for laundry. Likewise additionally appropriate standard furniture, like a cupboard, table or ironing board, can be provided in proximity to a domestic appliance. However the assistance that can be obtained for an operator from known sets is limited in any case to few activities; to date it has only been possible to obtain comprehensive assistance by way of the provision of additional furniture however again taking into account frequently narrow spatial limits that are set in a conventional household for the purposes of laundry, etc.

One object of the invention disclosed below is to develop the known set comprising a domestic appliance and an additional part to allow flexible, space-saving assistance for an operator that can optionally be adapted for different activities.

According to the invention therefore a set is indicated comprising a domestic appliance with a covering plate oriented perpendicular to a vertical and an additional part, which can be attached to the covering plate in such a manner that it projects from a wall, which is oriented approximately parallel to the vertical and adjoins the covering plate, with which set the additional part has a clamp which can engage partially over the covering plate and comprises a contact piece, which can be placed against the wall.

A universal holding device is thus provided on the domestic appliance for the additional part, being suitable for a plurality of different additional parts and also able to be produced easily and detached easily. Components of the holding device are a simple clamp on each additional part and a suitable cutout in the covering plate, in which the clamps engage, and which interacts with the contact piece, which braces the additional part against a wall of the domestic appliance, to hold the additional part. It is obvious that the covering plate can have a number of such cutouts, in order to be able to install a number of additional parts as required.

In a preferred development of the set the clamp comprises a pin and a slot oriented along the vertical is provided in the worktop, the pin being set up to engage in the slot. The pin means that this development provides a particularly efficient holding action for the clamp.

The wall of the domestic appliance is preferably a side wall.

Equally preferably the covering plate has a cutout, into which the clamp can be fitted so that the clamp forms a flat surface with the worktop away from the cutout. The flatness of the covering plate is thus maintained even when the additional part is used, this being advantageous for its use for folding laundry and the like.

The wall also preferably contains a ferromagnetic material and the contact piece at least one permanent magnet, which can press the contact piece against the wall. The holding of the additional part against the domestic appliance is thus improved by utilizing the magnetic force of the permanent magnet. Corresponding permanent magnets are known in principle; they can be made of alloys or compounds of the ferrous metals, for example iron oxides, optionally combined with other metals or oxides and then conventionally referred to as ferrites; permanent magnets made of compositions containing other metals, for example rare earth metals, are also known, for example compositions of aluminum, nickel and cobalt, samarium and cobalt or neodym, iron and boron.

Particularly preferred is a set in which the clamp is made of a plastic material that can be or is injection molded. Such plastic materials are essentially known as polyethylenes, polypropylenes and similar thermoplastic materials; they are readily available and economical to process and extremely suitable for use in additional parts.

Preferred examples of inventive additional parts, while not claiming to be exhaustive, are a container for detergent packs, clothes pins and so on, a clothes hanger holder, a support for a laundry basket or similar, a table, ironing board or drying rack. In particular all these additional parts are suitable for assisting with activities associated with laundry care in a normal private household.

In particular if the additional part is heavy or can be heavily laden, such as a table, ironing board or drying rack, an additional stay is preferably provided on the additional part to abut against the wall, in order to absorb the sometimes considerable forces reliably. The corresponding additional part also preferably has a first joint to fold away the additional part and a second joint to fold in the stay so that this additional part can also be stowed in a space-saving manner when not in use.

In a particularly preferred development of the set, the domestic appliance is positioned on a covering plate of a further generic domestic appliance, with an additional part attached to the covering plate. The invention is thus able to facilitate activities at such a tower made up of two domestic appliances, popularly a combination of washing machine (bottom) and dryer (top) in limited spatial conditions, in particular by using a number of additional parts. It is also preferable here for a gap to be provided between the covering plate and the domestic appliance, having a height that is greater than the height by which the clamp projects above the covering plate. It is not by any means excluded here that the gap could have a height of zero, in which case the covering plate must then have a cutout as described above, to accommodate the clamp in its entirety.

The domestic appliance in the set is preferably a laundry appliance, in particular a washing machine or tumble dryer.

Exemplary embodiments of the invention are described below with reference to the drawing, which should be considered to be a sketch and not necessarily a scale reproduction of actual exemplary embodiments, and in which specifically:

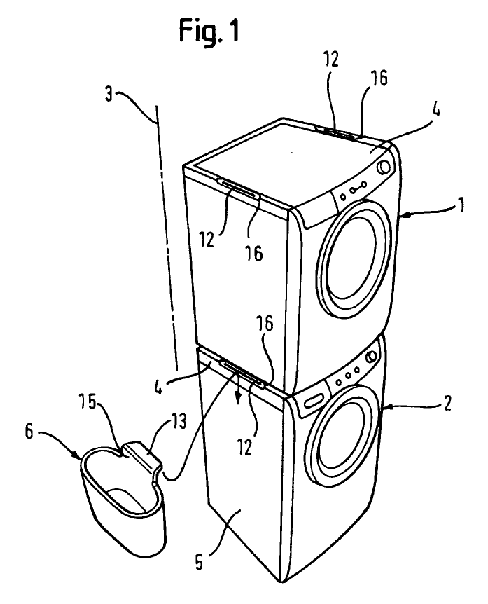

FIG. 1 shows two stacked domestic appliances with an additional device;

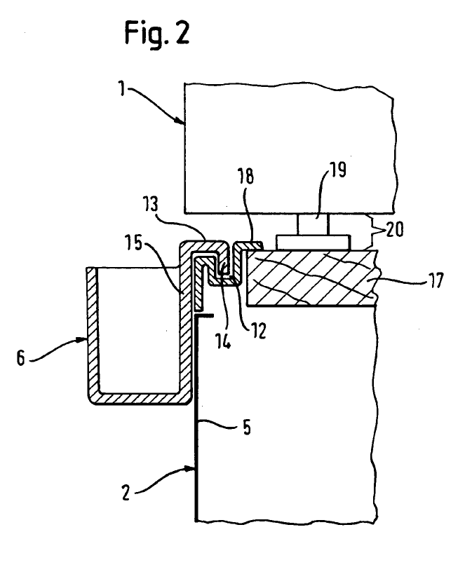

FIG. 2 shows a partial view of a section through the configuration according to FIG. 1;

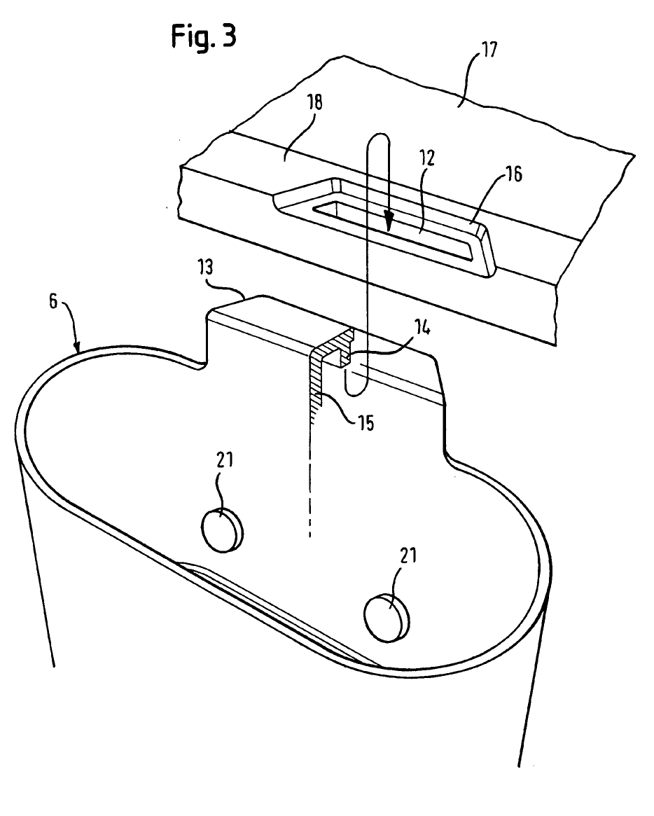

FIG. 3 shows a further view of a domestic appliance with an additional part;

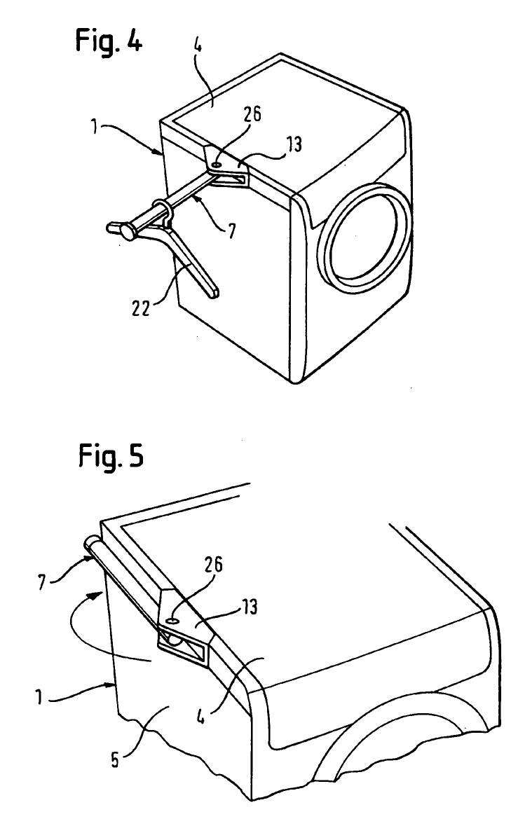

FIG. 4 and FIG. 5 show views of a domestic appliance with other additional parts;

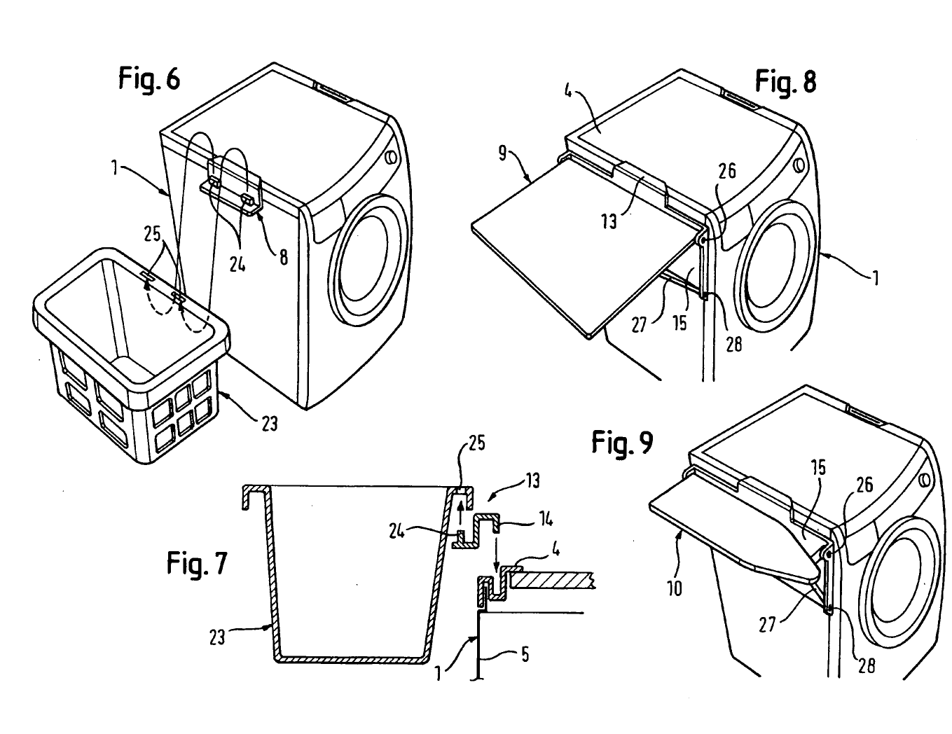

FIG. 6 and FIG. 7 show a view and cross section through a domestic appliance with a further additional part;

FIG. 8 and FIG. 9 respectively show a domestic appliance with an additional part;

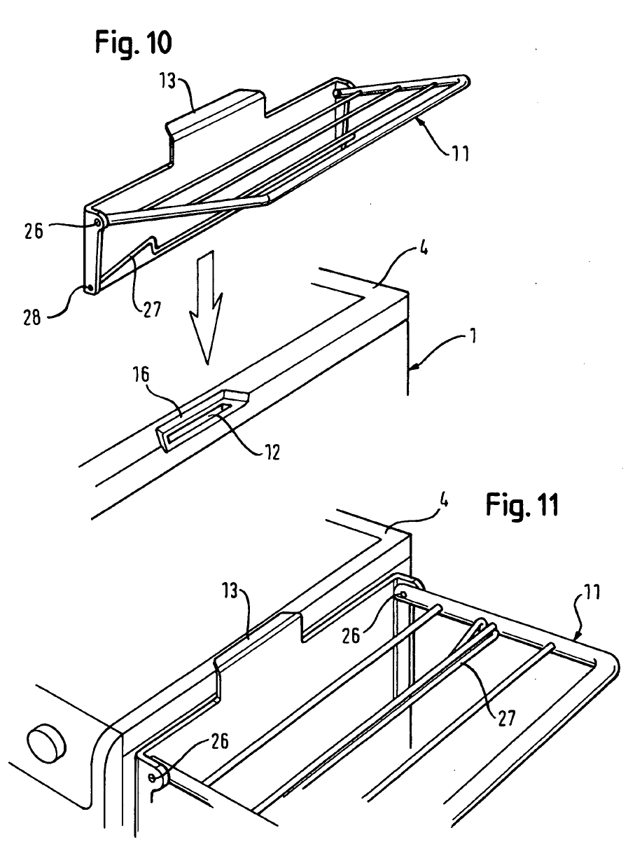

FIG. 10 and FIG. 11 show views of a domestic appliance and an additional part;

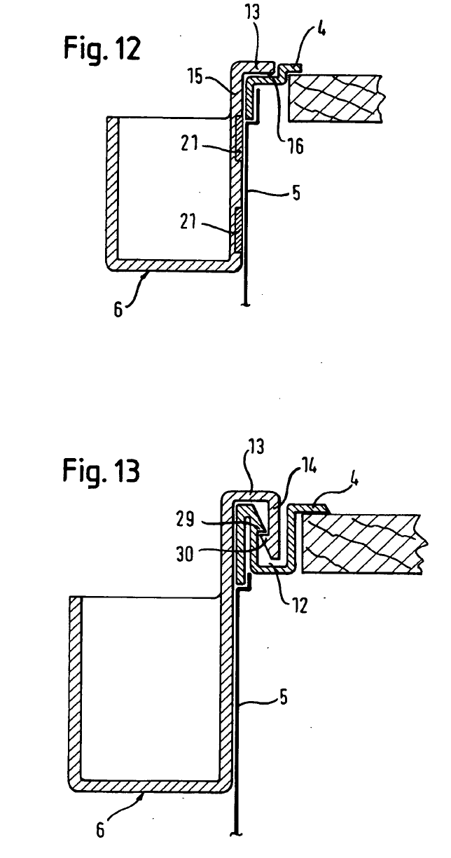

FIG. 12 and FIG. 13 show sectional views of developments of a domestic appliance and an additional part.

FIG. 1 shows two domestic appliances 1 and 2, namely a tumble dryer 1 and a washing machine 2, which are stacked on top of one another along a vertical 3, so that the tumble dryer 1 stands on a top face of the washing machine 2. Each domestic appliance 1 and 2 has a top face, which is covered by a covering plate 4. An additional part 6, namely a vessel 6, in which containers for washing agents, clothes pins and the like can be stored, is attached to the covering plate 4 and the side wall 5 of the lower domestic appliance 2. The vessel 6 is attached in a slot 12 in the covering plate 4 with a clamp 13. This clamp 13 has a pin 14 (see also FIGS. 2 and 3), which can be inserted into the slot 12. The clamp 13 also has a contact piece 15, which is placed against the side wall 5. The vessel 6 is fastened securely to the washing machine 2 in this manner.

A development of the set comprising the domestic appliance 2 and the vessel 6 is now described with reference to FIGS. 1, 2 and 3, in which a cutout 16 is provided in the covering plate 4, with the slot 12 arranged therein. The cutout 16 accommodates the clamp 13 in its entirety, so that the clamp 13 forms an essentially flat surface with the worktop 4 away from the cutout 16. The structure of the covering plate 4 shown in FIGS. 1 to 3 means that the surface is not completely flat as known with conventional domestic appliances. The covering plate 4 is made from a worktop 17, which can be made according to conventional practice of a wood/plastic composite and is essentially flat and a metallic edge profile 18 according to conventional practice rounding off said worktop 17. As shown in FIG. 2 and FIG. 3 the edge profile 18 rounds off the worktop in its entirety and the edge profile 18 also contains the cutout 16. The tumble dryer 1 stands with its feet 19 (of which only one foot 19 is shown) on the covering plate 4 of the washing machine 2, so that a gap 20 is formed; this gap must be at least so large that the clamp 13 fits under the tumble dryer 1. This can be seen clearly in FIG. 2.

FIG. 3 shows a development of the vessel 6 in that two permanent magnets 21 are provided in the wall of the vessel 6, which forms the continuation of the contact piece 15. When, according to conventional practice, the side wall 5 is made of a ferromagnetic material, in particular conventional steel, such permanent magnets 21 help to secure the vessel 6 to the domestic appliance 1. They assist with the fixing effect of the pin 14 and can even replace this in some instances see FIG. 12, which is described in detail below.

A further additional part 7 for a domestic appliance 1 can be seen in FIGS. 4 and 5, namely a clothes hanger holder 7. This clothes hanger holder 7 is secured to the clamp 13 in a movable manner; a corresponding first joint 26 is shown. As shown in FIG. 4, the clothes hanger holder 7 can be folded out from the domestic appliance 1, to hold a clothes hanger 22 (or a plurality of such clothes hangers 22). When the clothes hanger holder 7 is not required, it can be folded back against the domestic appliance 1 to save space, as shown in FIG. 5.

FIG. 6 and FIG. 7 show an additional part 8 in the form of a support 8 which can be used to hold a laundry basket 23 on the domestic appliance 1. As shown in FIGS. 6 and 7 a conventional laundry basket 23 has a flanged edge around it, which in some circumstances can itself be adequate to engage with the holder 8. To improve the holding action, two pins 24 are attached to the holder 8, to engage in corresponding slots 25 on the laundry basket 23. The manner in which the support 8 is secured to the domestic appliance 1 is shown most clearly in FIG. 7, which shows how the pin 14 of the clamp 13 of the holder 8 latches onto the domestic appliance 1.

A further embodiment of an additional part 9 is shown in FIG. 8, where the additional part is a table 9. The table 9 is anchored to the covering plate 4 in the described manner by means of a clamp 13. The contact piece 15 of the clamp 13 is extended in a downward direction with a stay 27 attached to it to brace the table 9. The table 9 can be folded down about a first joint 26 when not needed. To this end the stay 27, which can be pivoted about a second joint 28, is first folded in below the table 9. The table 9 can thus be folded into the domestic appliance 1 when it is not needed.

Yet another additional part 10 is shown in FIG. 9, namely an ironing board 10. Like the table 9 described above, this can be pivoted about a first joint 26 and is braced for use by means of a stay 27, which can in turn be pivoted about a second joint 28. The ironing board 10 can also be folded into the domestic appliance 1 when it is not required.

FIGS. 10 and 11 show a further additional part, namely a drying rack 11. This can also be anchored by means of a clamp 13 in a slot 12 in a cutout 16 in the covering plate 14. A stay 27 is also provided to brace the drying rack 11; the drying rack 11 can be pivoted about a first joint 26 and the stay 27 about a second joint 28, so that once the stay 27 is folded in, the drying rack 11 can be folded into the domestic appliance 1 when it is not in use.

FIG. 12 shows a development of the set with an additional part 6 in the form of a vessel 6. As an extension of the contact piece 15 of the clamp 13 the additional part 6 has two permanent magnets 21, which are so strong that they can hold the vessel 6 without the assistance of a pin 14. In this embodiment the clamp 13 is only an angled tongue, which rests in a corresponding cutout 16 in the covering plate 4. Materials for corresponding permanent magnets 21 are discussed above.

Another development of the set is shown in FIG. 13. Here a latching tab 29 is provided in the slot 12 in which the pin 14 is supported, with a latching tab 30 on the pin 14 interacting with said latching tab 29. The vessel 6 is thus latched to the domestic appliance 1 and cannot be removed by an unintended movement on the part of an operator.

### LIST OF REFERENCE CHARACTERS

1 Domestic appliance, tumble dryer
2 Further domestic appliance, washing machine
3 Vertical
4 Covering plate
5 Wall, side wall
6 Additional part, vessel
7 Additional part, clothes hanger holder
8 Additional part, laundry basket support
9 Additional part, table
10 Additional part, ironing board
11 Additional part, drying rack
12 Slot
13 Clamp
14 Pin
15 Contact piece
16 Cutout
17 Worktop
18 Edge profile
19 Foot
20 Gap
21 Permanent magnet
22 Coat hanger
23 Laundry basket
24 Pin on support 8
25 Slot in laundry basket
26 First joint
27 Stay
28 Second joint
29 Latching tab in slot 12
30 Latching tab on pin 14

1-12. (canceled)

13. A set including a domestic appliance having body formed by at least a substantially horizontally extending covering plate defining a worktop, a substantially vertically extending wall in generally perpendicular abutment with the covering plate, and an additional part configured for attachment to the covering plate in a manner wherein the additional part projects from the wall; the set comprising a clamp operatively associated with the additional part for engagement with the covering plate wherein the clamp includes a contact member configured for placement against the wall.

14. The set according to claim 13 wherein the clamp includes a pin and a generally vertically extending slot is formed in the worktop, the pin being configured to engage the slot.

15. The set according to claim 13 wherein the wall is formed as a side wall of the domestic appliance.

16. The set according to claim 13 wherein the covering plate is formed with a cutout configured for fitment of the clamp thereinto wherein the clamp forms a flat surface with the worktop spaced from the cutout.

17. The set according to claim 13 wherein the wall contains a ferromagnetic material and wherein the contact member contains at least one permanent magnet configured for biasing the contact member against the wall.

18. The set according to claim 13 wherein the clamp is formed from a plastic material that can be injection molded.

19. The set according to claim 13 wherein the additional part is formed as at least one of a vessel, a clothes hanger holder, a support for a laundry basket, a table, an ironing board and a drying rack.

20. The set according to claim 19 wherein the additional part includes a brace member for bracing abutment against the wall.

21. The set according to claim 20 wherein the additional part has a first joint for folding away the additional part and a second joint for folding in the brace member.

22. The set according to claim 13 wherein the domestic appliance is disposed on a covering plate of a second domestic appliance, with the additional part attached to the covering plate.

23. The set according to claim 22 wherein a gap is provided between the covering plate and the domestic appliance, the gap having a gapping dimension that is greater than the height at which the clamp projects above the covering plate.

24. The set according to claim 13 wherein the domestic appliance is a laundry appliance, in particular at least one of a washing machine and a tumble dryer.
